(19) United States
(12) Patent Application Publication
(10) Pub. No.: US 2006/0215735 A1
(43) Pub. Date: Sep. 28, 2006

(54) Method and device for encrypting a digital data stream in a transmission system

(76) Inventors: Francesc Dalmases, Aachen (DE); Joachim Kahlert, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/567,841

(22) PCT Filed: Aug. 3, 2004
(86) PCT No.: PCT/IB04/51363

§ 371 Date: Feb. 8, 2006

(30) Foreign Application Priority Data
Aug. 13, 2003 (EP) 03102523.2

(51) Int. Cl. H04B 1/707; H04K 1/10

(52) U.S. Cl. 375/146; 375/147; 375/260

(57) ABSTRACT

A method for encrypting a digital data stream (d^{(k)}) by means of a dynamic orthogonal spreading code (g₁^{(k)}, g₂^{(k)}g_{H}^{(k)}) and through the assignment of a hop interval (Iₕₒₚ), which varies from one connection to another. The degree of encryption is furthermore increased by varying the sequence of use of the content of a set (Gᵢ) of spreading codes, which is defined by stating the positions ({p_{—}1, p_{—}2 . . . p-MI) in a permutation function (Sᵢ).

The invention relates to a method for encrypting a digital data stream in a transmission system which has a transmitter for modulating a digital data stream and for transmitting the modulated digital data stream, as well as a receiver for receiving the modulated digital data stream and for recovering the digital data stream. In particular it relates to a transmission system that carries out the modulation or encryption on the basis of an orthogonal code. The invention also relates to such a transmission system.

The invention relates in particular to an encryption method that uses an orthogonal code for the modulation.

The invention furthermore relates to a transmission system that can be used for cordless as well as line-based networks. It can be used for single-carrier as well as multi-carrier modulation. In cordless transmission systems, it can be used for systems with a single antenna as well as for those with several antennae.

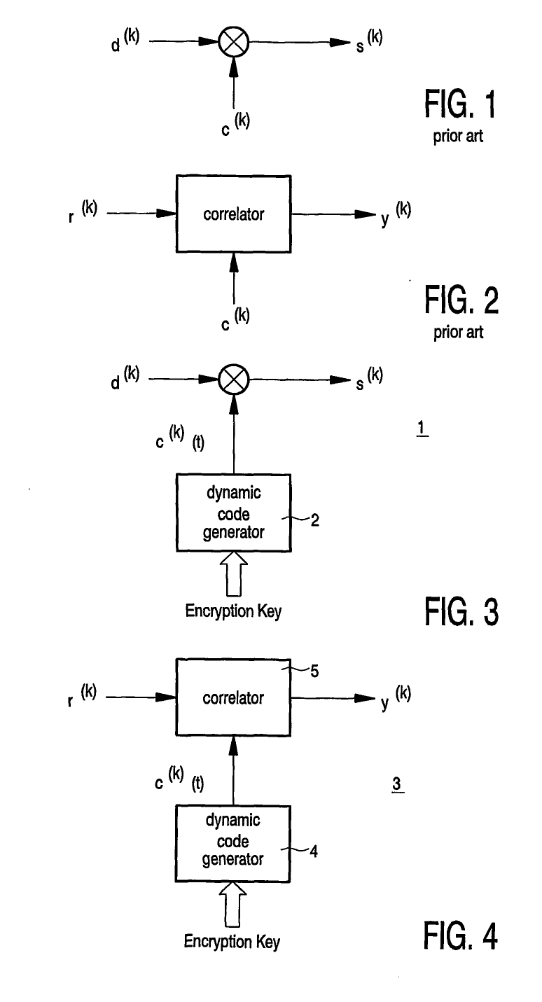

In the case of a transmission system in a cordless network, for example the CDMA (Code Division Multiple Access) method is used. The CDMA method carries out a division of the spectrum into a broad frequency band, referred to in the following as “spreading”. Two subscribers to the network who set up a connection use a particular code for the modulation and demodulation of the data stream. The spreading process is illustrated in FIG. 1 for the prior art. Here, the digital data stream comprises a successive sequence of symbols. Each symbol of the digital data stream d^{(k)} of the k^{th} connection (link) is multiplied during the entire connection by the same spreading frequency or by the same spreading code c^{(k)}. The spreading code c^{(k)} has the length P, for example 8 bits. This multiplication yields the spread signal s^{(k)}, which is expressed by the following equation (1):
s^{(k)}=c^{(k)}·d^{(k)} (1)

Here, the spreading code c^{(k)} is expressed through the following vector (2):
c^{(k)}=[c₀^{(k)}c₁^{(k)} . . . c_{P-1}^{(k)}]^{T} (2)

The vector stated in the equation (2) describes a spreading code c^{(k)} that is composed of positive and negative rectangular pulses as well as zero values. Its period T_{c} is a constant of P bits and expresses the duration of the validity of one of the elements c₀ to c_{P-1}.

If—as in the CDMA method—an orthogonal spreading code is used, the spread signal s^{(k)} can be received by the k^{th} subscriber as a reception signal r^{(k),} and the digital data stream can be recovered through correlation of the reception signal r^{(k)} with the same spreading code c^{(k)} that was also used in the mixing. Establishment of the spreading code takes place for example after connection set-up.

Since the CDMA method is used in networks in which different connections can be set up simultaneously, numerous different spreading codes exist. Here, each connection is assigned a different spreading code, so that the transmitted data can be decoded only by the authorized recipient.

The number of spreading codes used in the CDMA method is limited; the spreading codes themselves can be found out. During the entire data transmission from one network subscriber to another, according to equation (1) only the one spreading code c^{(k)}, established by the transmitting subscriber, is used. This leads to the situation that data streams that have been intercepted and stored by unauthorized receivers can be decoded through correlation of the received spectrum with various orthogonal codes. Such transmission systems are thus not secure against eavesdropping.

The patent application GB 2 331 207 A discloses a communication system that uses orthogonal codes in the CDMA method. In particular, it relates to an orthogonal multiple access system that divides the channels according to a hopping pattern of the orthogonal code. Here, the transmitter has a first generator for the orthogonal hopping code, which has an orthogonal code generator for producing the orthogonal code in accordance with a hopping pattern, and a hopping controller that is connected to the orthogonal code generator for producing the hopping pattern. In the case of one embodiment, the first generator for the hopping orthogonal code includes a memory for storing the orthogonal code for the output in accordance with the hopping pattern, and a hopping controller for producing the hopping pattern and for outputting the hopping pattern to the memory. Through the fact that the orthogonal codes for the encryption are filed in a memory and access to these orthogonal codes can be effected rapidly, the speed of encryption is increased. The patent application GB 2 331 207 also acknowledges that in encryption systems, the security of the encrypted data is higher, the more complex or varied the codes for the encryption are. For this reason, the British patent application proposes, in one embodiment, a transmitter in which each channel is assigned an orthogonal code comprising code symbols, which is used for the duration of the transmission. These orthogonal codes differ in respect of the duration of the validity of their code symbols, and in fact varies them in relation to a data unit (bit) of the digital signal. This means that the individual elements c₀^{(k)}, c₁^{(k)} . . . c_{P-1}^{(k)} of the P elements of a vector from equation (2) have the same period of validity, but that this period of validity is different from that of the elements of another connection. To put it another way, different orthogonal codes have different hopping periods Tₕₒₚ. Through the use of different orthogonal codes, which differ in terms of the hopping time Tₕₒₚ, for different channels an encryption function is realized on the transmitter side, or a decoding function is realized on the receiver side: however, this is aimed only at the overall communication system and not at the individual channels, each of which is assigned a spreading code that is to be used constantly. The orthogonal codes are produced by a Hopping Code Generator (HCG) in accordance with a hopping pattern that can be selected by the hopping controller. The hopping time of an individual orthogonal code can be shorter than the duration of a data unit, identical to the duration of a data unit, or an n-multiple of the length of a data unit, where n is a whole number.

The international patent application WO 02/056517 A1 discloses a method for operating a CDMA communication system, which in a coverage area of a base station assigns one spreading code out of a number of spreading codes to individual subscribers of a number of subscriber stations, and which then during transmission periodically hops between the spreading codes within the cell, and in fact within the quantity of spreading codes. So that at any given time, no two subscriber stations are working with the same spreading code, all subscribers are registered in a table containing the PN codes, with the subscribers being offset relative to one another. Within the table, the subscribers are moved to the same extent, so that they hop from one code to another whilst retaining their offset. Thus each subscriber works within the cell for a predetermined time segment with a different PN spreading code. The step of periodic hopping preferably changes from the currently-used spreading code to the next spreading code at a symbol rate or a multiple of the symbol rate. The system can be one with a fixed data rate or with a variable data rate. What is decisive here is that all subscribers registered in the table are moved to the same extent, so that their offset is maintained and it is thus ensured that each subscriber works with a different spreading code. In order to ensure this, the allocation of the spreading codes and of the pattern for the hopping takes place in a centralized and co-ordinated manner. The pattern for the hopping is established and is known to every subscriber, so that it is ensured that the distance between the subscribers in the table is maintained. By hopping from the currently-used spreading code to another spreading code, any interference that may be present between two subscribers is reduced.

It is an object of the present invention to define a method for encrypting a digital data stream in a transmission system that uses orthogonal codes for the modulation, which increases the security of the data stream against eavesdropping. It is furthermore an object of the invention to define a method for decoding a digital data stream that has been transmitted encrypted. It is furtermore the task of the invention to define a device for carrying out such a method. It is furthermore an object of the invention to defme such a transmission system for a digital data stream that uses orthogonal codes for the modulation, and has increased security against eavesdropping.

Increasing the degree of encryption by varying the encryption, as described in claim 1, during an existing connection, makes it more difficult for an unauthorized third party to find out the content of the data stream on the basis of intercepted data by trying out all known spreading codes, since each individual spreading code, even if it is actually known, is applied only for a short time, and then in a quasi-random sequence another spreading code from the established quantity is applied and/or the length of the hop interval from one spreading code to the next is varied.

The assigned sequence for the application of the different spreading codes is valid only for a single k^{th} connection, and is known only to the transmitting and the receiving device. This sequence is not produced centrally and is not assigned to several connections, so that the assigned sequence for a particular connection is not known to others. Here, the sequence is established by the transmitting device and is for example produced by a random generator or taken from a table stored in a memory. The sequence for the use of the different spreading codes is preferably of a random nature here.

The hop intervals assigned to a k^{th} connection indicates the validity for a spreading code, and can be defined as a period, i.e. a time-related period of validity, or as a number of data packets. The hop interval is established decentrally by the transmitting device, and is notified to the receiving device. This means that in a network in which several connections exist simultaneously, with these connections respectively using a set of spreading codes, these can have content-related overlaps, such that individual connections could from at times certainly use identical spreading codes, but these would be used simultaneously only temporarily, since after the expiry of the hop interval another spreading code would be used.

The sequence for the use of the content of a set of spreading codes can bedefined by a permutation function which is constructed as a vector and which states the respective position of the spreading code that is to be used at that moment. In the first place of the vector is the position of the first spreading code that is to be used, in the second place the position of the second spreading code to be used, etc. In all, the permutation function includes M elements. Once the vector has been run through once, the allocation is started again at the first position, in the manner of a loop. The positions of the spreading code are preferably stated by whole numbers.

In the case of the method described in claim 3, after the connection has been set up the parameters required for the transmission and recovery of the digital data stream are transmitted by means of an encryption key. Through the communication of the encryption key, the following steps are triggered:
establishment of a permutation function,
establishment of a set of spreading codes, and/or
establishment of a hop interval,
   wherein one, two or all three of the last steps mentioned above can be carried out, and indeed in any order, since the communication of the encryption key is concluded before the transmission of the digital data stream begins.

In the case of the method for encrypting a digital data stream described in claim 4, a first permutation procedure is executed, which contains a loop with the following steps:
setting of an interval to “1”;
waiting for the end of a predefined hop interval;
increasing the interval by the value 1;
carrying out a comparison to see whether the current value of the interval is greater than the total number of elements of a permutation function which states the positions of the spreading code of a set of spreading codes that is to be used for encrypting the digital data stream, wherein alternatively the following takes place:
if the comparison has a positive result: resetting of the interval to “1”;
if the comparison has a negative result: equating the current spreading code with the spreading code that stands at the position stipulated by the permutation function.

This method describes the definition or allocation of the spreading code that is to be used respectively at a given time.

With regard to the device for carrying out an encryption procedure, the task of the invention is fulfilled in that the device has a first code generator that produces the respectively current spreading code. Here, the production of the respectively current spreading code can take place contemporaneously during encryption, or can be concluded before encryption, wherein then the spreading codes to be used during encryption are for example stored in a table in a ROM or other memory.

With regard to the method for decoding a received digital data stream that was transmitted encrypted, according to the invention the task is fulfilled through the execution of a second permutation procedure that contains a loop with the following steps:
setting an interval to “1”;
waiting for the end of a predefined hop interval;
increasing the interval by the value 1;
carrying out a comparison to see whether the current value of the interval is greater than the total number of elements of a permutation function which states the positions of the spreading code of a set of spreading codes that is to be used for decoding the encrypted digital data stream, wherein alternatively the following takes place:
if the comparison has a positive result: resetting of the interval to “1”;
if the comparison has a negative result: equating the current spreading code with the spreading code that stands at the position stipulated by the permutation function.

The loop describes here ensures that the received signal is respectively decoded with the same code that was used for encryption, and through this the digital data stream is recovered.

With regard to the device for carrying out a decoding method, according to the invention the task is solved in that the device has a second code generator that produces the current spreading code. Here, the current spreading code can be produced contemporaneously during decoding, or can be produced in advance and stored in a suitable memory. In this case, a second code generator means that both the transmitting device and the receiving device have a code generator. The code generator that is used during the kh connection as the second code generator, namely as the code generator for the decoding, can also be the first code generator used for the encryption during another connection.

With regard to the transmission system for a digital data stream that uses orthogonal codes for the modulation, according to the invention the task is fulfilled in that the transmission system has a first device in which the digital data stream is mixed with a spreading code, and has a second device in which the received, encrypted signal and the spreading code are supplied to a correlator, and the transmission system has means for
carrying out encryption,
carrying out decoding of a digital data stream that was transmitted encrypted.

These means can be a clock generator, a memory (ROM) for storing the spreading code and the instructions which are communicated with the aid of the encryption key.

The method according to the invention for encrypting and decoding a digital data stream can be used in both cordless and line-based networks, wherein the level of the degree of encryption and thus the level of protection against unauthorized eavesdropping can be adapted to the respective requirement.

Advantages of the invention are that the degree of encryption is increased during data transmission, whilst the necessary bandwidth remains unchanged. This advantage is achieved through the fact that the encryption of the digitized data takes place in the physical layer (layer 1) of the OSI 7-layer model.

In this connection, the degree of encryption stands for a level of complexity. The measures
1) use of a set of different spreading codes,
2) use of a permutation function and/or
3) use of a hop interval that is of different lengths for different connections can be used individually or in combination. The more measures are realized, the higher the level of complexity and thus of the degree of encryption. Complexity is further increased by the use of factors of greater content and thus through greater variety.

The invention is elucidated below only on the basis of examples, wherein

FIG. 1 shows schematically a CDMA transmitter according to the prior art;

FIG. 2 shows schematically a CDMA receiver according to the prior art;

FIG. 3 shows a device for encryption in accordance with the invention, in a schematic representation;

FIG. 4 shows a device for decoding in accordance with the invention, in a schematic representation;

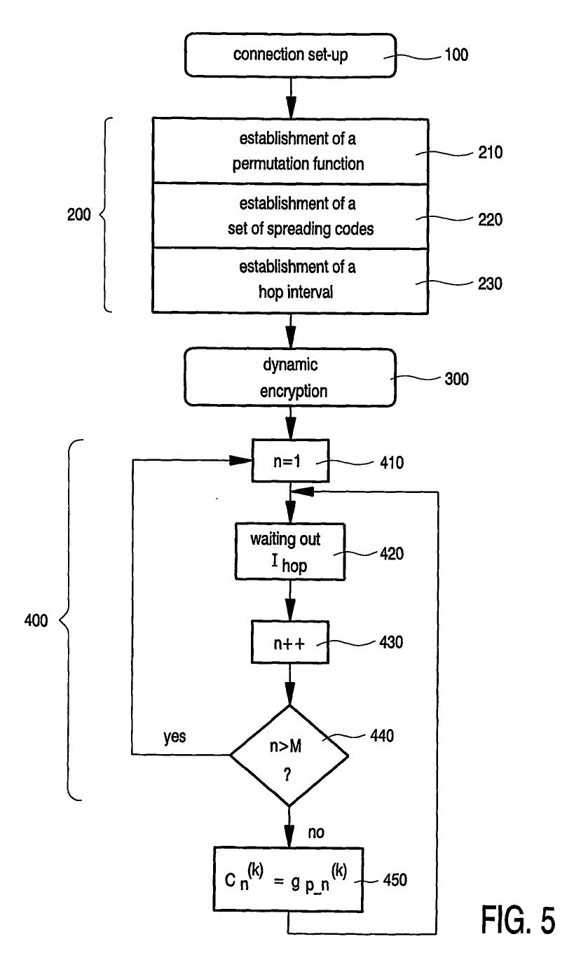

FIG. 5 shows in a schematic representation a flow chart [for] a method in accordance with the invention, for encrypting a digital data stream;

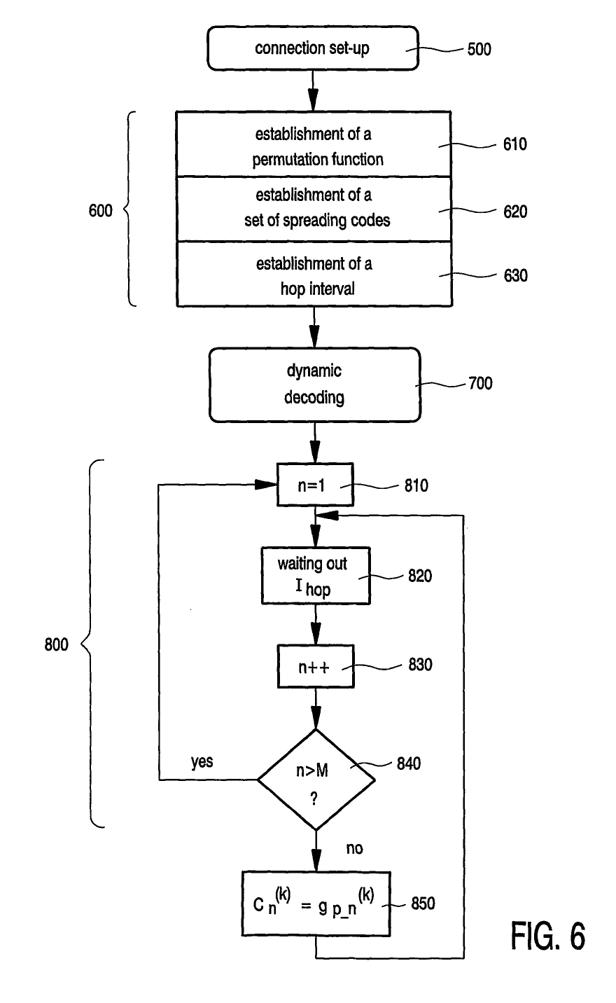

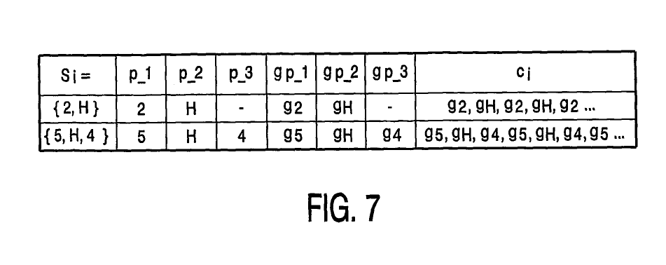

FIG. 6 shows schematically, in a flow chart, a method in accordance with the invention, for decoding and recovering a digital data stream, and FIG. 7 contains a table with certain permutation functions.

With regard to the prior art, FIG. 1 shows schematically a transmitter for transmission with the CDMA method. The digital data stream d^{(k)} of the k^{th} connection is mixed with a spreading code c^{(k)}. The transmission signal s^{(k)} that is created thus is sent to the receiving subscriber, either cordlessly or line-based. The spreading code c^{(k)} is constant for the duration of the connection. An unauthorized receiver can intercept the transmission signal s^{(k)} and store it, and could determine, by trial and error, the single spreading code that was used.

With regard to the prior art, FIG. 2 shows schematically a CDMA receiver, which adds the coded input signal r^{(k)} in a correlator to the same spreading code c^{(k)}. The one spreading code c^{(k)} is notified to the receiver for the k^{th} connection. If that spreading code c^{(k)} is used in the correlation which was also used in the case of encoding, the received signal r^{(k)} can be decoded and thus the digital data stream y^{(k)} can be recovered.

FIG. 3 shows, in a schematic representation, a device 1 in accordance with the invention, for encryption for the CDMA transmission system. The digital data stream d^{(k)} is mixed with a dynamic code c^{(k)}(t) here. A dynamic code generator 2 produces orthogonal codes of differing content, and controls their use, so that during a connection different spreading codes are used. With an encryption key that is communicated after the connection has been set up, amongst other things a quantity Gi of orthogonal codes {g₁^{(k)}, g₂^{(k)} . . . g_{H}^{(k)}} is established. During a connection, one after another at least two codes from the quantity G6 are used. The designation of the dynamic spreading code c^{(k)}(t) is intended to mean that during the connection, the encryption varies, for example through the application of a first code c₁^{(k)}, a second code c₂^{(k)} etc. Depending on the duration of the connection or the definition of the hop interval Iₕₒₚ of a spreading code, individual codes or all the codes can be used several times. By changing the spreading code during the transmission, a first degree of encryption is achieved.

FIG. 4 shows, in a schematic representation, a device 3 in accordance with the invention, for decoding the received signal r^{(k)} and for recovering the digital data stream y^{(k)} in a transmission system. Here, the received signal r^{(k)} is supplied to a correlator just as the dynamic code c^{(k)}(t) is. A dynamic second code generator 4 creates orthogonal codes of different content and controls their use, so that during a connection different spreading codes are applied. The application of different spreading codes during a single connection is intended to be visualized through the illustration (t) and through the adjective “dynamic”.

The dynamic code generator 2 for the transmission device 1 and the code generator 4 for the receiver device can be physically the same ones. For example, a mobile radio telephone has a part for transmitting and a part for receiving, wherein according to one embodiment of the invention, both make use of the same dynamic code generator.

In a flow chart, FIG. 5 schematically shows a method in accordance with the invention, for encrypting a digital data stream. Following on from the connection set-up 100, in step 200 the encryption key is communicated. This triggers the following, in any order:
the establishment of a permutation function Sᵢ 210;
the establishment of a set of spreading codes Gᵢ 220;
the establishment of a hop interval Iₕₒₚ 230.
   The encryption key is created by the transmitting unit and contains the parameters necessary for decoding the transmitted data signal.

The permutation function Sᵢ={p_1, p_2 . . . p_M} indicates in which order the individual codes g₁^{(k)}, g₂^{(k)} . . . g_{H}^{(k)} of the set Gᵢ are applied. The establishment 210 of the permutation function that is valid for the current transmission can alternatively take place through:
a) communication of a vector Sᵢ which includes the concrete permutation sequence {p_1, p_2 . . . p_M}, or
b) communication only of the name of a single permutation function Sᵢ.

Alternative a) enables an unauthorized third party subscriber to eavesdrop the permutation sequence and thus to obtain an aid for decoding the digital data stream that has been transmitted. However, this method has the advantage that storage space is saved on both the transmitter and receiver sides, since the permutation sequence that is valid for the current communication needs only to be stored in the buffer memory, and can be deleted after the ending of the transmission.

Alternative b) requires that on both the transmitter and receiver sides, all the possible permutation functions S₁, S₂ . . . S_{L} (L: whole-number) have to be permanently stored, so that the permutation function Sᵢ that is valid for the transmission can be called up. The advantage of this variant is that an unauthorized third party subscriber cannot find out the sequence of orthogonal codes Gᵢ that lies behind the permutation function Sᵢ that is used, since it is not communicated, wherein H and P are whole numbers.

A set Gᵢ contains H individual orthogonal codes that are suitable for use in the CDMA method. Here, each individual one of the H orthogonal codes g is built up as a vector with P elements.

The step of establishing a set Gᵢ of spreading codes 220 can alternatively take place either through
c) Communication of the concrete individual orthogonal codes in the form of vectors or
d) communication of the names of the orthogonal codes that are to be used.

The advantages and disadvantages of alternatives c) and d) are, as in the case of alternatives a) and b) when establishing the permutation function Sᵢ, that communication of the concrete details reduces security against eavesdropping, and that the saving and calling up of predefined orthogonal codes takes up memory space on both the transmitter and receiver sides.

Step 230, for establishing the hop interval Iₕₒₚ, alternatively means either
e) stipulation of a period Iₕₒₚ, i.e. of a time-related duration of validity, or
f) stipulation of a quantity Q of data packets.

After communication of the encryption key, the dynamic encryption 300 begins. The first permutation procedure 400 is as follows: at step 410 the interval n is set to “1”, that orthogonal code from the set Gᵢ is used that stands at the place p_1 of the permutation function Sᵢ. At step 420, the expiry of the hop interval Iₕₒₚ is waited for. The measuring of time for establishing the end of the period, or the counting of the data packets that have been transmitted, takes place through corresponding devices such as for example a counter or a flip-flop. When the end of the hop interval Iₕₒₚ has been reached, in step 430 the interval n is increased by the value 1. At step 440 the comparison is then carried out to see whether the current value for the interval n is greater than the total number M of the elements of the permutation vector. If the comparison yields the answer “yes”, the loop starts against with step 410 and the interval n is set to “1” again. If the result of the comparison is “no”, in step 450 that code is called up as a current code cₙ^{(k)} which stands at the n^{th} position p_n of the permutation function Sᵢ, i.e. cₙ^{(k)}=gₚ_{_{—}}ₙ^{(k)} and it is used until, in the course of the loop, in step 420 the end of the hop interval Iₕₒₚ is reached and subsequently in step 430 the interval n is increased by the value 1.

Shown schematically in FIG. 6, in a flow chart, is a method in accordance with the invention, for decoding and recovering a digital data stream. The encryption key, which is communicated in step 600, following on from the connection set-up 500, triggers the following:
the establishment of a permutation function Sᵢ 610;
the establishment of a set of spreading codes Gᵢ 620;
the establishment of a hop interval Iₕₒₚ 630.

As already explained for FIG. 5,
the establishment 610 of the permutation function that is valid for the current transmission can alternatively take place through either communication of a vector Sᵢ which contains the concrete permutation sequence {p_1, p_2 . . . p_M}, or through communication only of the name of an individual permutation function Sᵢ,
the step for establishing a set Gᵢ of spreading codes 620 can take place alternatively either through communicating the concrete individual orthogonal codes in the form of vectors or communicating the names of the orthogonal codes that are to be used, and/or
the step 630 for establishing the hop interval Iₕₒₚ can alternatively mean the stipulation of either a period Tₕₒₚ, i.e. a time-related period of validity, or a quantity Q of data packets.

After the communication of the encryption key, the dynamic decoding 700 begins. The first permutation procedure 800 is as follows: at step 810 the interval n is set to “1”, that orthogonal code from the set Gᵢ is used which stands at the place p_1 of the permutation function Sᵢ. At step 820 the expiry of the hop interval Iₕₒₚ is waited for. The measuring of time for determining the end of the period, or the counting of data packets that have been transmitted, is carried out by corresponding devices such as for example a counter or a flip-flop. Once the end of the hop interval Iₕₒₚ has been reached, in step 830 the interval n is increased by the value 1. At step 840 the comparison is then carried out to see whether the current value for the interval n is greater than the total number M of the elements of the permutation vector. If the comparison yields the answer “yes”, the loop starts again with step 810 and the interval n is set to “1” again. If the result of the comparison is “no”, in step 850 that code is called up as the current code cₙ^{(k)} which stands at the n^{th} position p_n of the permutation function Sᵢ, i.e. cₙ^{(k)}=gₚ_{_{—}}ₙ^{(k)}, and this is used until, in the course of the loop, in step 820 the end of the hop interval Iₕₒₚ is reached and subsequently in step 830 the interval n is increased by the value 1.

FIG. 7 contains a table with examples for particular Permutation functions Sᵢ={p_1, p_2 . . . p_M} and the code cᵢ that follows from that. Here, p_1, p_2, . . . p_M are any whole numbers 1, 2 . . . H. If a particular permutation function is e.g.: s={2, H}, this means that p_1=2 and p_2=H, and in encryption first of all the spreading code g₂ and subsequently the spreading code g_{H} is applied. If the connection has not yet ended then, encryption is continued in the manner of a loop, with p_l, i.e.g₂, and then with p_2, i.e. g_{H}.

1. A method for encrypting a digital data stream in a transmission system that uses orthogonal codes for the modulation, wherein—a k^{th} transmitter constructs a k^{th} connection for the k^{th} digital data stream (d^{(k)}),—for the encryption, the digital data stream (d^{(k)}) of the transmitter is mixed with a spreading code that is assigned to this k^{th} connection,—different spreading codes (g₁^{(k)}, g₂^{(k)} . . . g_{H}^{(k)}) from a defined set (Gᵢ) are assigned and—through the mixing a transmission signal (S^{(k)}) is produced, characterized in that the degree of encryption of the k^{th} digital data stream (d^{(k)}) is increased during the k^{th} connection through the allocation of ● a sequence for the application of the different spreading codes (g₁^{(k)}, g₂^{(k)} . . . g_{H}^{(k)}) and/or a hop interval (Iₕₒₚ).

2. A method as claimed in claim 1, characterized in that a permutation function (Sᵢ) defines the sequence of the application of the content of a set of spreading codes (Gᵢ) by stating the position ({p_1, p_2 . . . p_M}).

3. A method for encrypting a digital data stream that is to be transmitted, wherein after the connection set-up, necessary parameters for the transmission and recovery are transmitted, characterized by the steps:
communication of an encryption key (200) and thus:
establishment (210) of a permutation function (Sᵢ),
establishment (220) of a set (Gᵢ) of spreading codes, and/or
establishment (230) of a hop interval (Iₕₒₚ),
wherein the last three steps mentioned (210, 220, 230) can be carried out in any order.

4. A method for encrypting a digital data stream, characterized by the execution of a first permutation procedure (400) which contains a loop with the following steps:
setting (410) of an interval (n) to “1”;
waiting (420) for the end of a predefined hop interval (Iₕₒₚ);
increasing (430) the interval (n) by the value 1;
carrying out a comparison (440) to see whether the current value of the interval (n) is greater than the total number (M) of the elements of a permutation function (Sᵢ) which states the positions of the spreading code (gₙ) of a set (Gᵢ) of spreading codes that is to be used for encrypting the digital data stream, wherein alternatively the following takes place:
if the comparison has a positive result: resetting of the interval (n) to “1”;.
if the comparison has a negative result: equating the current spreading code (gₙ) with the spreading code (gₚ_{_{—}}ₙ) that stands at the position (p_n) stipulated by the permutation function (Sᵢ) .

5. A device (1) for carrying out a method as claimed in claim 1, characterized in that the device has a first code generator (2) that creates the respectively current spreading code (gₙ).

6. A method for decoding a received digital data stream that was sent encrypted, characterized by the execution of a second permutation procedure (800) that contains a loop with the following steps:
setting (810) an interval (n) to “1”;
waiting (820) for the end of a predefined hop interval (Iₕₒₚ);
increasing (830) the interval (n) by the value 1;
carrying out a comparison (840) to see whether the current value of the interval (n) is greater than the total number (M) of the elements of a permutation function (Sᵢ) which states the positions of the spreading code (gₙ) of a set (Gᵢ) of spreading codes that is to be used for decoding the encrypted digital data stream, wherein alternatively the following takes place:
if the comparison has a positive result: resetting of the interval (n) to “1”;
if the comparison has a negative result: equating the current spreading code (gₙ) with the spreading code (gₚ_{_{—}}ₙ) that stands at the position (p_n) stipulated by the permutation function (Sᵢ)

7. A device (3) for carrying out a method as claimed in claim 6, characterized in that the device (3) has a second code generator (4) that produces the current spreading code (gₙ).

8. A transmission system that uses orthogonal codes for the modulation, with a device for encrypting a digital data stream, in particular a device (1) as claimed in claim 5, wherein the digital data stream (d^{(k)}) is mixed with a spreading code, and with a device for decoding a digital data stream that was sent encrypted, characterized by the execution of a second permutation procedure (800) that contains a loop with the following steps:
setting (810) an interval (n) to “1”;
waiting (820) for the end of a predefined hop interval (Iₕₒₚ);
increasing (830) the interval (n) by the value 1;
carrying out a comparison (840) to see whether the current value of the interval (n) is greater than the total number (M) of the elements of a permutation function (Sᵢ) which states the positions of the spreading code (gₙ) of a set (Gᵢ) of spreading codes that is to be used for decoding the encrypted digital data stream, wherein alternatively the following takes place:
if the comparison has a positive result: resetting of the interval (n) to “1”;
if the comparison has a negative result: equating the current spreading code (gₙ) with the spreading code (gₚ_{_{—}}ₙ) that stands at the position (p_n) stipulated by the permutation function (Sᵢ), characterized in that it has means for
carrying out encryption,
carrying out decoding of a digital data stream that was transmitted encrypted.

9. Use of one of the methods mentioned above in a cordless or line-based network.
